(19) United States
(12) Patent Application Publication
(10) Pub. No.: US 2014/0201014 A1
(43) Pub. Date: Jul. 17, 2014

(54) PROCESS FOR PAYMENT BY CELL PHONE TO A MERCHANT OBJECT OF THE INVENTION

(71) Applicant: JUAN JOSÉ RIDER JIMENEZ, CORDOBD (ES)

(72) Inventor: JUAN JOSÉ RIDER JIMENEZ, CORDOBD (ES)

(21) Appl. No.: 13/739,012

(22) Filed: Jan. 11, 2013

(51) Int. Cl. G06Q 20/32

(52) U.S. Cl. CPC G06Q 20/322
USPC 705/21

(57) ABSTRACT

The cell phone user interested in paying for his/her purchases in commercial establishments without the need to physically use a credit card installs in his/her cell phone an mPAY application configured to make payments through the cell phone. The commercial establishment, in which the mPAY customer has made his/her purchase, makes from his/her mPOS application, configured to accept payments from cell phones provided with mPAY, a payment request to the mPAY/mPOS server, which is the remote system which allows asynchronous communication between the mobile payment application of the customer's cell phone and the mPOS application of the commercial establishment, sends a PUSH message to the customer's cell phone activating therewith the mobile payment application thereof.

### OBJECT OF THE INVENTION

The present invention refers to a process by which the cell phone user can pay for his/her purchases in commercial establishments by means of an application pay by cell phone, or mPAY installed in the cell phone which is activated upon receiving contact from a mobile payment server or mPOS/mPAY server, which has received a request from an mPOS application installed in the commercial establishment so that it contacts that cell phone and supplies it with the details of the sale and the amount payable, never the card ones, there being initiated between seller and customer an actuation protocol which consists first in the authentication that the holder of the cell phone is the holder of at least one credit card linked to the mPOS/mPAY protocol, appearing together with the form in which the payment cards are related with the digital signature of the customer. The seller can also access the same protocol through TPV/PC/etc. When the customer's cell phone is connected to the server platform of mPAY/mPOS a GPS positioning protocol can be activated which compares the location of both, thus guaranteeing that the purchase is in-person and not authorizing the operation if not. Later the customer closes or does not close the sale operation choosing one of the payment cards registered in the mPOS/mPAY system and authorizing or not authorizing the purchase, thus perceiving more security in the transaction. A purchase ticket in electronic format, which helps save paper, accredits that the transaction has been made successfully, appearing on the screen of the cell phone of the seller and of the buyer.

The invention solves the problem of the cost which is entailed for the merchant in the use of a TPV/PIN-PAD, above all in the case of micro payments. It also seeks to solve the problem of the handling of credit cards with the obligation inherent therein to comply with PCI-DSS, Payment Card Industry Data Security Standard, which secures and protects the processing of the cards and the cardholders data in order to prevent frauds which involve misuse thereof, a standard compliance with which the merchants or credit card service providers must periodically validate. The present invention frees them from complying with this obligation. In summary, in using the mPOS application, PCI regulations are not breached, given that the critical data of the customer, those which are contained in the card, never come into the possession of the merchant nor is introduced the financial PIN.

This invention also solves the impossibility of making payments on the move such as in the case of delivery people, vending machines, delivery people, etc. so that it is ideal for micro payments under 12 Euros.

With the use of this system the customers do not need to be in physical possession of the card at the moment of the purchase.

When the customer authorizes the operation using his/her cell phone, the merchant not having to use a TPV/PIN-PAD, possible fraud can advantageously be reduced by comparing the GPS positioning of both cell phones (customer/merchant) such that it is guaranteed that the purchase is in-person.

Among the advantages of the present invention the ease of the micropayments stands out and the need for the purchase of a TPV/PIN-PAD is eliminated. Although the beginning of the payment operation can be made from a phone, it can also be started from a device such as a PC, TPV or PINPAD. The side of the merchant is the mPOS platform. Another advantage of the system when fighting fraud is the use of digitalized signature capture in the cell phone. On the other hand, although the customer can choose the card with which he/she wishes to pay in his/her cell phone, the way in which they are presented to the user is in masked format, that is leaving visible for example only the first 6 digits and the last 4 so that in no case the identification number of the card is fully shown nor in the mPAY platform of the customer nor in the mPOS of the merchant.

The customer will be able to purchase without the need to have a physical card, and moreover virtual cards may be used with the consequent saving on the card issuance costs.

Making use of geolocation in the customer's cell phone, it is guaranteed that the purchase is in-person.

Its industrial application falls within the cell phone communication systems sector and more specifically in payment system to merchants through cell phone.

### BACKGROUND OF THE INVENTION

Although no invention identical to that which is compared has been found, the documents found which reflect the state of the technique related to the proposed invention are set out below.

Thus the document ES 2 140 365 T1 refers to a manual mobile terminal to financial transactions which comprises: A first card reader to read a customer card; A secure numerical keyboard; A display device; A processing device to receive details from this first card reader and from the secure numerical keyboard, in order to conduct out any required local processing, visualizing the necessary messages on this screen and communicating with a main remote computer if necessary; an interface device to allow the communication and control the signals which are sent to a communication device and are received therefrom; and a mechanical retention device, which forms a single piece with said terminal to connect this communication device in a movable way to the mentioned terminal and in operational contact with the aforementioned interface device, so that the communication device and the terminal constitute, from the operational point of view, an integrated manual unit, and allows the selective removal of the communication device, which can function independently when it is separated from the mentioned terminal. The mentioned communication device is a conventional cellular phone, with a connection which allows controlling and communicating signals introduced from an external device. Moreover, it includes readers for cards such as commercial smart cards, customer smart cards and magnetic customer swipe cards, as well as interfaces to peripheral devices and a printer to hand over a receipt. It also includes means to receive an information storage device or a connection thereto, as well as a medium to carry SAMs.

Commentary: It is a technology from the year 1998 which is already far superseded by the current technology, such that it could not be deduced that it interferes with the novelty of the compared invention.

ES 2 125 825 B1 is an electronic purse system for public telephones, which includes microprocessor card readers device, modem for communication by telephone line, external interface RS-232 and telephone line decoder, characterized by two components, a card payment management system chip (A) and a telephone/card interface payment management system (B), both interconnected to each other, which supports different types of electronic purses simultaneously, manages the telephone calls and the payment transactions, controls the device status, controls consumption and manages the purse, detects the destination of the calls, and authorizes free calls. The payment management system (A) has two security modules (S) and a cryptographic security processor (C) which allows it to be totally compatible with most of the currently existing chip cards. It carries out the remote management of the transactions and of the status of the telephone for the operating Company, sending details to a control center upon request or upon reaching a certain level of coins, notifying of the alarm situations and being able to download the details related to those transactions, either through a modem (M) and the line itself or through an RS-232 interface or infrared (I).

The invention found refers to a card payment system for the use of the public telephone, not of a cell phone, which is very different to the compared invention.

ES 2 290 558 T3 describes a process to access a payment system (ZS) of a telecommunication network (TKN), the payment system (ZS) being configured for the execution of electronic payment operations, the telecommunication network (TKN) having an access node (ZK) for access through external service providers to the telecommunication network and a supplier details report (ADS), in which the access durations assigned to the service providers are stored and in which a standard access duration for service providers is stored, which are unknown in the telecommunication network, process in which
a service computer (DR) of a service provider external to the telecommunication network accesses (2) the access node (ZK),
the access node (ZK) determines the identity of the service provider,
after a satisfactory determination of the identity an access framework (ZKZ) is generated and is transmitted (4, 5) to service computer (DR), after which the service computer (DR) accesses (6) the payment system (ZS) by means of the access framework (ZKZ) avoiding the access node (ZK),
at the latest with the access of the service computer (DR) to the payment system (ZS) a time measurement is begun and the measure time duration in this respect is compared with the access duration of the service provider, and
Once the value of the measure time duration reaches the access duration, the access framework (ZKZ) is declared invalid, after which access (6) of the service computer (DR) to payment system (ZS) is impeded by means of the access framework (ZKZ).
After a satisfactory determination of the identity the access node

(ZK) it reads from the supplier details report (ADS) the access duration assigned to the corresponding service provider and transmits it to the payment system (ZS),
the payment system (ZS) generated the access framework

(ZKZ) and assigns it to the access duration,
the payment system (ZS) transmits (4) the access framework

(ZKZ) to the access node, and
the payment system (ZS) executes the stages of the time measurement, the comparison and the declaration of invalidity.
the access node (ZK) transmits (3) to the payment system together with the access duration a message to initiate a payment development,
then the payment system begins a payment development and it is related with the access framework (ZKZ) and—when the service computer (DR) accesses (6) the payment system (ZS) with the access framework (ZKZ) the payment development assigned thereto is directed.
A payment system (ZS) is used which can execute payment operations both by exhausting a payment credit (DS2) paid in advance as well as generating invoice details (DS1) which can later be paid.
Between the service computer (DR)s and the access node (ZK) a first interface (S1) is made of details using messages built according to HTTP specifications.
Between the service computer (DR)s and the access node (ZK) a first interface (S1) is made of details using messages built according to XML specifications.

It is a system devised in the year 2003 to access a payment system (ZS) from a telecommunication network (TKN), either through a computer or through a cell phone

ES 2 200 675 A1 refers to a transaction and payment system by means of cell phone. A system to process payments and transactions between payers (7) and beneficiaries (9) associated with at least one means of payment associated with an account of at least one processor (5), which is connected to a plurality of cell phone networks (1), so that it comprises a payers access node (2) and a beneficiaries access node (3) for each mobile phone network (1), and which comprises an addressing processor (4) provided with the corresponding means to permit making the transaction between different payers and beneficiaries through different mobile phone networks and between different financial entities. Moreover, the system of the invention allows make the management of the payers, such as the registration or de-registration of the holder, registration, de-registration or modification of the means of payment. The invention also allows make operations as at an ATM such as balances, most recent operations, change to the security parameter or top-up of the cell phone.

It is a Spanish patent from 2002 referring to payments by cell phone between payers and beneficiaries associated with the system, in which it is necessary to highlight a fundamental difference, and it is that this system, although it uses the cell phone to authenticate/authorize the operations, does not involve the cell phone being connected to a phone line or the communication between the parties being made by means of telephone networks, but rather the communication is through the internet.

ES 2 015 453 refers improvements in a prepaid mobile telephone system, cellular, autonomous, consisting of a standard telephone set with a radio transceiver and a micro-telephone, as well as a means for reading credit cards, it has a mechanism for collecting and rejecting coins, a collecting box and accessories interface box which allows the easy recovery of coins from the collecting box, without compromising the security of the telephone system. Moreover, it has an accessories interface to allow the connection and functioning of peripheral machines.

ES 2 263 344 A1 is a method to make secure payment transactions, using programmable cell phones. The use of programmable telephones—such as with Java technology—, in which an application (e.g. Java application) is loaded, allows their use as secure payment terminals. The application allows the buyer/seller to make the transaction, including the verification, in a single connection. The sent details are encrypted and transmitted by means of GPRS or another detail transmission protocol to a transaction server, where the transactions are verified and authorized. The security of the process mainly confers to it the use of up to five unrelated identification elements, including a unique access key to each user, stored in the cell phone.

ES 2 170 166 T3 refers to a payment systems mobile in real time for the payment of invoices by cell phone users and/or which provides the users with all types of means for making bank transactions, of retail and commercial businesses and the sending and receiving of information, in which the system uses resources from the short message transmission service of at least one cordless mobile communications network or of a cordless digital communication system (5) and an identification module of the payment/user (SIM or equivalent 10, 21, 39, 42), in which the system comprises
at least one mobile terminal (1, 6, 8, 37, 41) which uses the mentioned identity module (10, 21, 39, 42) and which include means to introduce, transmit, receive, handle and show (11) information which is essentially related but not limited to: the payment of invoices of the telephone payment or of the user of the mentioned mobile terminal; the transfer of money from the bank account of the payment or user into other accounts; the sending and receiving at least of payment messages of (11, 13, 18, 19, 20, 25, 29, 33, 34, 35) or of messages which include the balance of the account, the status of the account or the operations of the bank account (33, 34, 35) of the telephone payment or of the user of the mobile terminal (1, 6, 8, 37, 41), messages about payments and commercial transactions and other messages which are required (11);
at least one computer station (2, 14, 24) located in a bank (3) or other places which are required, which computer station includes means for direct communication by means of short messages with the mentioned mobile terminal or through the means of message transmission of the telecommunication network (4, 5) and to transfer the amount of the payment from the account of the user of the mobile terminal or of the telephone payment to another account (17, 28), or from a customer account, whose information about the account is introduced into the mentioned mobile terminal, a another account; and/or to receive and send messages about the balance of the account, the status of the account or the operations of the account (11, 33, 34, 35) of the payment of the mobile terminal or user and the communication of bank messages, about payments, related to commercial operations and other messages which are required (11);
at least the cordless mobile communications network (4, 15, 26) or a cordless digital communications system (5) through which the mentioned mobile terminal can send to and receive from the mentioned computer station the mentioned messages about payments and/or at least messages about the balance of the account, the status of the account, or the operations of the account of the user or of the payment of the mentioned mobile terminal, and communicate bank messages, of payments and/or related to the merchant and other messages which are required (11).

### DESCRIPTION OF THE INVENTION

The process for payment at to a merchant through cell phone which is the subject of the present invention consists of the cell phone user interested in paying for his/her purchases in commercial establishments whether they are merchant, restaurant, travel agency, repair workshop, industry, etc. without the need to physically use a credit card, installs in his/her cell phone an mPAY application configured to make payments through cell phone. The commercial establishment in which the mPAY customer has made his/her purchase from his/her mPOS application, configured to accept payments from cell phones provided with mPAY, a payment request to the mPAY/mPOS server, which is the remote system which allows the asynchronous communication between the mPAY application of the customer's cell phone and the mPOS application of the commercial establishment, sends a PUSH message to the customer's cell phone activating therewith his/her mPAY application which begins with the authentication of which the holder of the application is holder of at least one credit card linked to the mPOS/mPAY protocol. It continues with the acceptance or denial of the payment by the customer. If he/she accepts, the customer chooses the card with which to make the payment and finally authorizes it. In the exchange of information between customer and server the card identification numbers are protected by a specific encryption code per device as well as in masked format, so that for security nobody shall be able to know the content or decipher it except the application installed in the customer's cell phone or mPAY itself.

Once all the purchase information has been gathered, both the details of the merchant (amount, code of the merchant, etc.) and those of the cardholder (card identifier), the server authorizes the payment processing gateway so that the card of the customer is charged for the purchase amount and this amount is paid to the account of the commercial establishment. Lastly the mPAY/mPOS server informs the commercial establishment of the confirmation or where appropriate denial of the payment and in the event of confirmation sends a receipt accrediting the purchase to both the customer and the establishment.

In a different carrying out of this process, when the two phones are connected, a GPS positioning protocol is activated which compares the location of both, thus guaranteeing the purchase is in-person and not authorizing the operation if not.

Then, the customer authorizes or does not authorize the purchase, thus perceiving more security in the transaction. A notification that the transaction has been made successfully for the agreed amount appears on the screen of the cell phone of both the seller and the buyer. In an alternative carrying out, mPAY system can work not only in a cell phone but also in a Tablet, iPad, etc. such that the identifier to which we refer for the payment requests, the phone number, can be extended to the use of other identifiers such as an email.

In a different carrying out the seller can also access the same mPOS protocol through TPV.

### BRIEF DESCRIPTION OF THE DRAWINGS

For a greater understanding thereof, some drawings of a practical carrying out of the present invention are appended to the present report by way of a non-limiting example.

In those drawings:

FIG. 1: Scheme of the process

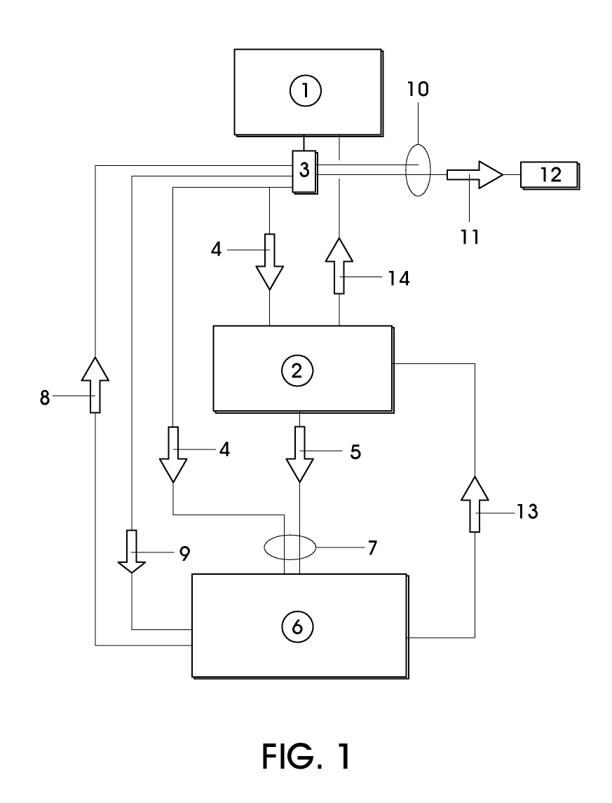

The numbering which appears in the FIGURE corresponds to the following elements or phases constituting the process

1) Customer

2) Commercial establishment

3) Customer's cell phone

4) mPAY application in customer's cell phone

5) mPOS application in commercial establishment

6) MPAY/mPOS server

7) Asynchronous communication between mPAY and mPOS

8) PUSH Message to mPAY

9) Authentication of card linked to the protocol mPAY/mPOS

10) Acceptance or denial of the

11) Authorization of the payment

12) Charge of the purchase amount on the customer's card

13) Payment of the amount to the account of the establishment

14) Receipt accrediting of the purchase

### DESCRIPTION OF A PREFERRED CARRYING OUT

A preferred carrying out is constituted from the following configuration: The user (1) of cell phone (3) interested in paying for his/her purchases in commercial establishments (2) be these merchant, restaurant, travel agency, repair workshop, industry, etc. without the need to physically use a credit card, installs in his/her cell phone (3) an mPAY application (4) configured to make payments by cell phone. The commercial establishment (2) in which the mPAY customer (4) has made his/her purchase made from his/her mPOS application (5), configured to accept payments from cell phones provided with mPAY (4), sends a payment request to the mPAY/mPOS (6) server, which is the remote system that allows the asynchronous communication (7) between the mPAY application (4) of the cell phone (3) of the customer (1) and the mPOS application (5) of the commercial establishment (2), sends a PUSH message (8) to the cell phone (3) of the customer (1) activating therewith the mPAY application (4) thereof which begins with the authentication of which the holder of the application is holder of at least one credit card linked to the mPOS/mPAY protocol (9). It continues with the acceptance or denial of the payment (10) by the customer (1). If he/she accepts, the customer (1) chooses the card with which to make the payment and finally authorizes it (11). In the exchange of information between customer (1) and server (6) the card identification numbers are protected by a specific encryption code per device as well as in masked format, such that for security nobody shall be able to know the content or decode it except the application itself installed in the customer's cell phone or mPAY (4).

Once all the purchase information has been gathered, both the details of the merchant (amount, merchant code, etc.) and those of the card holder (card identifier), the server (6) authorizes the payment processing gateway to charge (12) for the purchase amount from the card of the customer and to pay (13) that amount to the account of the commercial establishment (2). Lastly the mPAY/mPOS (6) server informs the commercial establishment (2) of the confirmation, or where appropriate denial, of the payment and in the event of confirmation sends a receipt (14) accrediting the purchase both to the customer and to the establishment, the customer thus perceives more security in the transaction. A notification that the transaction has been made successfully for the agreed amount appears on the screen of the cell phone of the seller and of the buyer.

1. A process for payment by cell phone to merchant, characterized in that the user (1) of a cell phone (3) interested in paying for his/her purchases in commercial establishments (2) be these merchant, restaurant, travel agency, repair workshop, industry, etc. without the need to physically use a credit card, installs in his/her cell phone (3) a mobile payment application (4) configured to make payments by phone, and the commercial establishment (2) in which the customer realized payment through his/her cell phone (4) of his/her purchase, makes from its mobile charging application (5), configured to accept payments from cell phones (3) provided with the mobile payment application (4), conducting such commercial establishment a payment request to the mPAY/mPOS server (6), which is the remote system that allows asynchronous communication (7) between the mobile payment application (4) of the cell phone (3) of the customer (1) and the mPOS application (5) of the commercial establishment (2), sends a PUSH message (8) to the cell phone (3) of the customer (1) activating therewith the mPAY application (4) thereof which begins with the authentication of the fact that the holder of that application is the holder of at least one credit card linked to the mPOS/mPAY protocol (9), continuing with the acceptance or denial of the payment (10) by the customer (1) and in the event of accepting, the customer (1) chooses the card with which to make the payment and finally authorises it (11).

2. A process for payment by cell phone to merchants, according to claim 1, characterized in that once all the purchase information has been gathered, both the details of the merchant (amount, merchant code, etc.) and those of the cardholder (card identifier), the server (6) authorizes the payment processing gateway so that it charges (12) for the purchase amount from the card of the customer and pays (13) such amount to the account of the commercial establishment (2).

3. A process for payment by cell phone to merchants, according to claim 1, characterized in that the mPAY/mPOS server (6) informs the commercial establishment (2) of the confirmation, or where appropriate denial, of the payment and in the event of confirmation sends a receipt (14) accrediting the purchase both to the customer and to the establishment. A notification that the transaction has been made successfully for the agreed amount appears on the screen of the cell phone of the seller and of the buyer.

4. A process for payment by cell phone to merchants, according to claim 1, characterized in that in the exchange of information between customer (1) and server (6), the card identification numbers are protected by a specific encryption code per device as well as in masked format.

5. A process for payment by cell phone to merchants, according to claims 1 to 4, characterized in that in a different carrying out from this process, when the two phones are connected, a GPS positioning protocol is activated which compares the location of both, thus guaranteeing that the purchase is in-person and not authorizing the operation if not.

6. A process for payment by cell phone to merchants, according to claims 2 to 5, characterized in that in an alternative carrying out the mobile payment system can function not only in a cell phone but also in a Tablet, iPad, etc. so that the identifier to which we refer for the payment requests, the telephone number, can be extended to the use of other identifiers such as an email.

7. A process for the payment by cell phone to merchants, according to claims 2 to 5, characterized in that in a different carrying out the seller can also access the same mPOS protocol through a POS device.
